(19) United States
(12) Patent Application Publication
(10) Pub. No.: US 2002/0117042 A1
(43) Pub. Date: Aug. 29, 2002

(54) Electronic virtual console for an organ

(76) Inventors: Kevin Light, Myerstown, PA (US); Randall Walker, Zionsville, PA (US)

Correspondence Address: EDWARD J. CHALFIE, SUITE 341, 47 WEST POLK STREET, CHICAGO, IL, 60605, US

(21) Appl. No.: 10/054,763

(22) Filed: Jan. 18, 2002

Related U.S. Application Data
(60) Provisional application No. 60/262,750, filed on Jan. 18, 2001.

(51) Int. Cl. G09B 15/04

(52) U.S. Cl. 84/478

(57) ABSTRACT

An electronic virtual organ console is provided to be used in lieu of an actual organ console as a component of a church or theater organ. The present invention provides an interface between an electronic (MIDI) keyboard and the components of the organ that produce the sounds, or voices, of the organ. These components may be either those of a pipe organ or an electronic organ. The virtual console is operated been command inputs into a touch-sensitive screen monitor.

### FIELD OF THE INVENTION

The present invention relates generally to musical organ controls, and more particularly to an electronic virtual console interface for controlling an organ.

### BACKGROUND OF THE PRESENT INVENTION

A traditional pipe organ is typically provided with at least two keyboards, a pedal board, a number of stops, couplers, and pistons to control the sounds produced by air moving through pipes of varying lengths. Originally, these mechanical control means, actuated by an organist's fingers, hands and feet, were mechanically coupled to devices for controlling the flow of air to the pipes, and in some cases, for adjusting the length of the pipes.

Familiarity with the following pipe organ terminology will be of assistance in understanding this invention.

Basic Controls

To those that have played the piano, the organ is similar in some respects—for example, in the shape and layout of the keys—but there are many differences. For example, an organ keyboard typically has 61 keys (as opposed to 88 on a piano), and there are at least two keyboards on any typical organ. Also, there is a pedalboard (typically 32 keys) that is played by the organists' feet.

The sound that the organ makes is also controllable by choosing which sets of pipes in the organ get played on what keyboard, and at what pitch. These determinations are made with controls that are known as the stops (The term “stops” comes from their original purpose in a traditional pipe organ, i.e., to ‘stop’ the flow of air into a particular set of pipes. The term “pulling out all the stops” has its roots in organ-playing.)

The stops are the most powerful tool at the organist's disposal. They allow him/her to choose the pipe sets to be played. Each set of pipes in the organ is called a rank; ranks for the manuals (i.e., the keyboards) typically have at least 61 pipes (one per note) and for the pedal, 32 pipes per rank. Each rank is described by its pitch; the pitch of a rank is the length in feet of the longest pipe in the rank. (Though, if the pipes have stopped ends instead of open ones, the pitch is double the length of the longest pipe as the stopper causes the natural wavelength of the pipe to halve). For example, a rank called Open Flute 8′ has a longest pipe that is (roughly) 8 feet long. The stops are labeled by the rank and the pitch that they play; since the longest pipe makes the lowest note, the pitch indicates the length of the pipe that is connected to the farthest left key on the keyboard CC.

A stop list for a particular manual might look like this:

Diapason 8′

Flute 8′

Gemshorn 4′

Principal 2′

This manual, then, can play a flute and diapason at 8′ pitch, a gemshorn at 4′ pitch, and a principal at 2′ pitch—and these ranks can be played in any combination, which makes the organ so versatile. In fact, with just these 4 stops, there are 16 possible combinations that can be selected. Volume can also be controlled by the stops to a certain extent—the more stops selected, the louder the sound will be as more pipes are being played. Also, by choosing stops with short pitches, a higher-sounding tone can be produced.

Organ Layout

In a standard pipe organ, each keyboard (manuals and pedal) plays a separate division or group of ranks. These divisions are grouped, and named, according to the kinds of sound they make. Traditionally, in an organ with three divisions (two manuals plus one set of pedals) the ranks are GREAT (the lower keyboard) SWELL (the upper keyboard,) and PEDAL. Great and Swell get their names due to the fact that the Great typically has the loudest pipes in the organ and hence the “greatest” sound. The Swell normally has its pipes enclosed in a box or chamber with shutters on the front that can be opened or closed by a foot control at the console. If the shutters are opened while the division is being played, the music seems to “swell up”—and thus the name. The Great and Pedal divisions are typically not enclosed; however, in some small organs divisions may be enclosed.

Couplers

Another unique feature of organs is the ability to play one keyboard from another by the means of controls called the couplers. These controls allow the organist to “connect” (usually electronically, but in the case of older organs, mechanically) a keyboard to one or more of the keyboards above it on the console. So, for example, a coupler labeled “Swell to Great” allows the organist to play the stops that are selected on the Swell division from the keys on the Great keyboard. This gives greater range to the music as it provides for more overall combinations of stops. In electronic organs, couplers can also change the pitch of the keyboard that is coupled. For example, a coupler labeled Swell to Great 4′ connects the stops on the Swell to the Great at one octave higher than they would be if played on the Swell (8′ is standard pitch). Similarly, one labeled Swell to Great 16′ connects the Swell to the Great at one octave below the pitch selected on the Swell stops.

Occasionally, one will find unison couplers on an organ—these are couplers that connect a keyboard to itself at either one octave above or one octave below the pitch of the stops selected. For example, if a 4′ Flute on the Great as well as a coupler that reads “Great to Great 16′” were selected, one will hear the 4′ Flute originally selected, plus that note one octave down the scale. (i.e., playing the middle C note and also hearing the C below it). These couplers allow further combinations to be selected; they are more commonly found on theatre organs than on church organs.

Pistons

One desire of all organists is to be able to quickly set or reset a particular combination of stops (especially on an organ with many stops—some have more than 200 stops) To this end, organ builders developed the use of pistons—small, usually white, buttons placed underneath a keyboard (or toe-studs above the pedalboard) which, when pressed, will cause the stops to set themselves to a combination that the organist had previously programmed. Most organs also have a CANCEL piston which turns all the stops and couplers off when it is pressed.

Pistons come in two varieties—generals and divisionals. The generals allow the stops on the entire organ to be set—useful for making large changes. Divisionals only affect the stops on one division (e.g. Great, Swell, etc.) and are generally used for more subtle changes.

### SUMMARY OF THE INVENTION

The present invention provides an electronic interface touch-sensitive screen between the organist and the sound-producing components of the organ to provide a consoleless church or theater organ, which can be played with only an electronic keyboard and the virtual organ console.

The virtual organ console is not an entire organ, but is rather an interface between an organ player and an organ voice generation system, which may generate sound through pipes or electronically. That is, it is not only applicable as an interface between an organ player and an electronic organ voice generation system, but it can include pipe driver boards, such that it may be used to play pipes, just as in a regular pipe organ.

### BRIEF DESCRIPTION OF THE DRAWINGS

FIG. 1 is a view of a prior art organs's draw knobs;

FIG. 2 is a view of a prior art organs's lighted draw knobs;

FIG. 3 is a view of a prior art organs's lighted piston buttons;

FIG. 4 is a view of a prior art organs's expression indicators;

FIG. 5 is a view of a prior art organs's console;

FIG. 6 is a schematic view of the virtual organ control system according the present invention;

FIG. 7 is screen view of the virtual organ control system according the present invention;

FIG. 8 is a general perspective view of an electronic MIDI keyboard used with the virtual organ control system according the present invention; and

FIG. 9 is a general perspective view of a touch-sentitive screen monitor used with the virtual organ control system according the present invention.

### DESCRIPTION OF THE PREFERRED EMBODIMENT

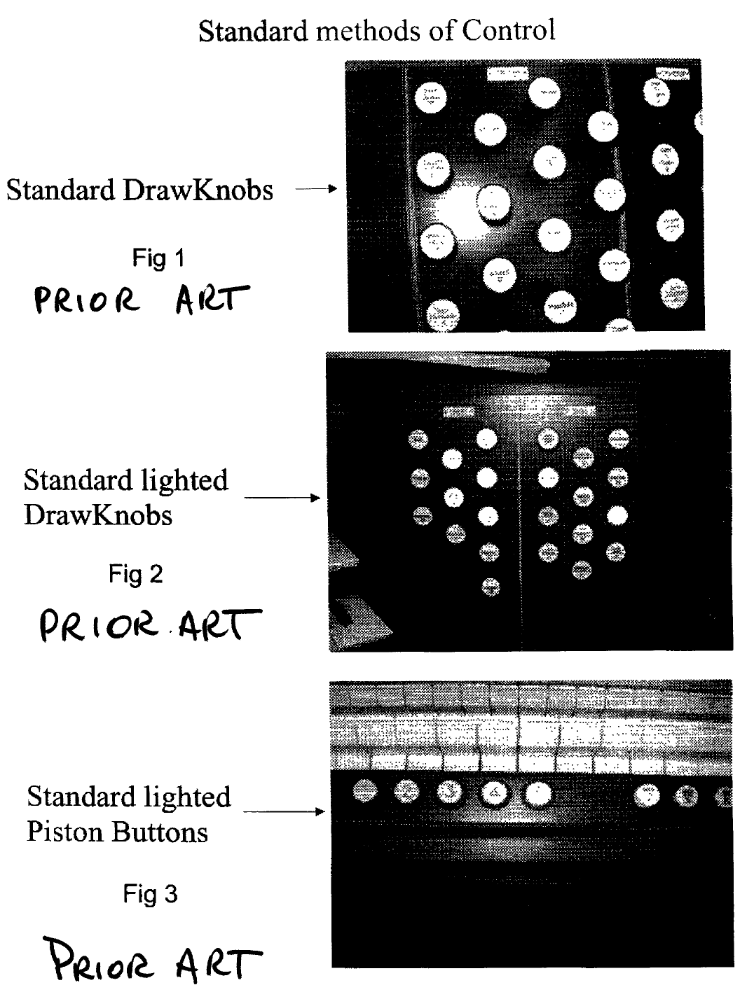

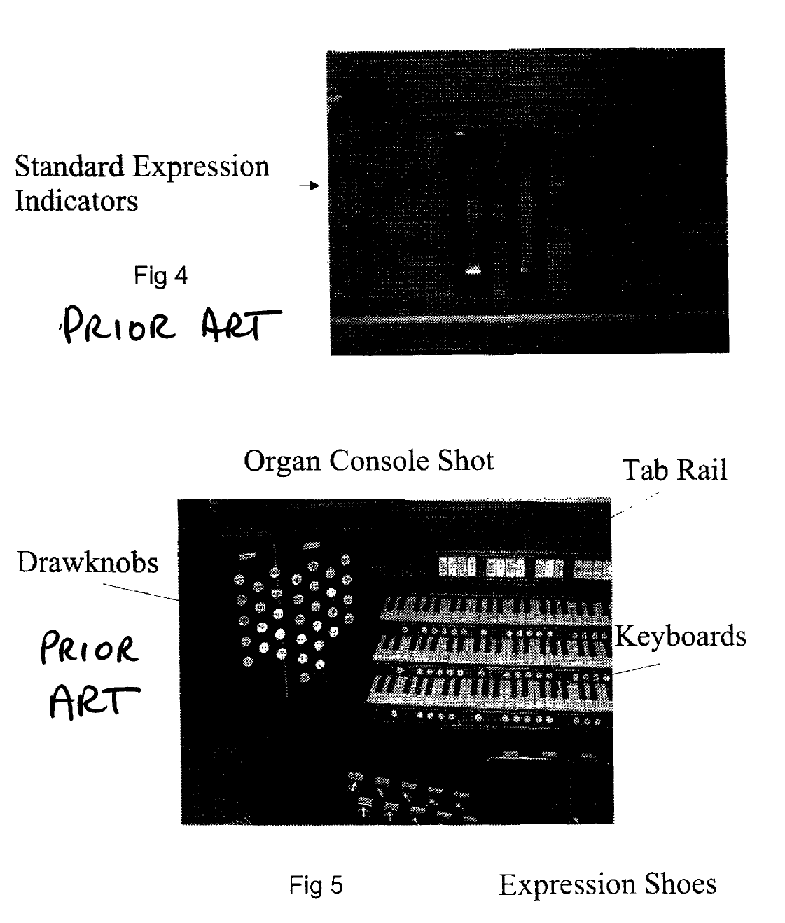

The standard manual and pedal operating controls and displays of a typical prior art organ are shown in FIGS. 1-5. As indicated on the legends accompanying the Figures, the control devices include draw knobs (lighted or unlighted), piston buttons, a tab rail, keyboards, foot operated buttons, and foot operated expression shoes. Also, as shown FIG. 4, expression indicators are provided to be readily observed by an organ player.

In accordance with this invention, a virtual organ console or electronic operating system for a organ is provided by the combination of one or more electronic keyboards and one or more touch-sensitive electronic display screens. Other than the keyboard, all of an organ's controls, including drawknobs, memory pistons, and coupler tabs, are displayed on one or more touch-sensitive electronic display screens. The user is able to select a rank or combination of ranks to be played by simply touching the desired preprogrammed drawknobs and coupler tabs on the screen. In the same way, memory banks, to aid in changing registrations, may be set by touching the memory pistons on the screen. “Previous” and “next” buttons are also incorporated to select a desired adjacent memory piston. The instrument is then played using external MIDI keyboards and expression shoes. The expression shoe levels are indicated on the screen as well.

In general, the virtual organ console contains the same features and responds much like that of a conventional organ console, but is contained on a touch-sensitive electronic display screen or screens.

The virtual organ console is both an interface for the user and the controlling system for the organ. On a conventional organ, a console controller board is used to determine the note to be played on specific ranks form data output from the console controls (i.e., keyboards, drawknobs, pistons, etc.). Alternatively, the virtual organ console does all of the control processing itself and therefore the console controller board is not needed. The external keyboards are connect to electronic control circuitry, or computer, via MIDI and the expression shoes are connected to the electronic control circuitry, or computer, via a joystick interface, so that when a particular note is played on a specific keyboard the computer knows exactly which key is depressed.

The virtual organ console processes the active controls and keys designated by the user. The computer then passes that information on to an electronic sound generation unit, where audio signals are generated and an output provided to amplifiers. Additionally, the information can be sent to pipe controller computers, which translate the information to control and a traditional pipe organ.

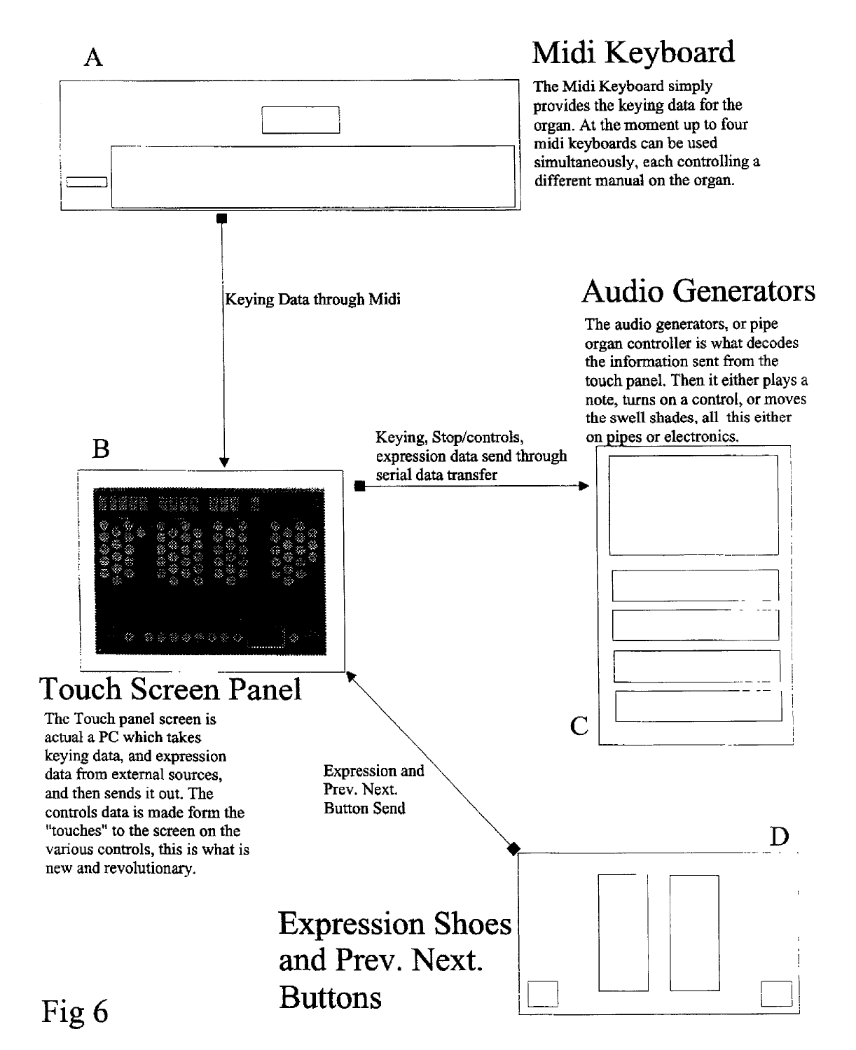

Reference is now made to FIG. 6, which depicts in block diagram form the several components of the virtual organ console of this invention used to control an organ voice generation system. As shown at A, one or more MIDI keyboards are provided for keying data to be used to control the organ voice generation system. The MIDI keyboard provides the keying data for the organ. If more than one keyboard is used, each controls a different manual on the organ.

A personal computer's touch-sensitive screen panel is shown at B. The touch-sensitive electronic display panel shown at B is associated with electronic control circuitry, in the form of a personal computer, which takes data from the MIDI keyboards and one or more touch-sensitive screen panels, including expression shoes and “previous”—“next” buttons as shown at D, to provide electronic data to control the audio generators shown as C. The personal computer runs software that packetizes keying data from a MIDI keyboard A and retransmits it through a serial port to the electronic sound generator or pipe controller C.

The Touch panel personal computer also serves as a means of turning on and off the stops and controls of an organ through the use of “touches” to the screen, on the various icons of the controls. These touches produce data to be sent out the serial port to the sound generator or pipe controller C. Expression for the swell shades is provided through expression shoes D attached to the touch panel personal computer B. This data is send out the serial port to the sound generator or pipe controller C.

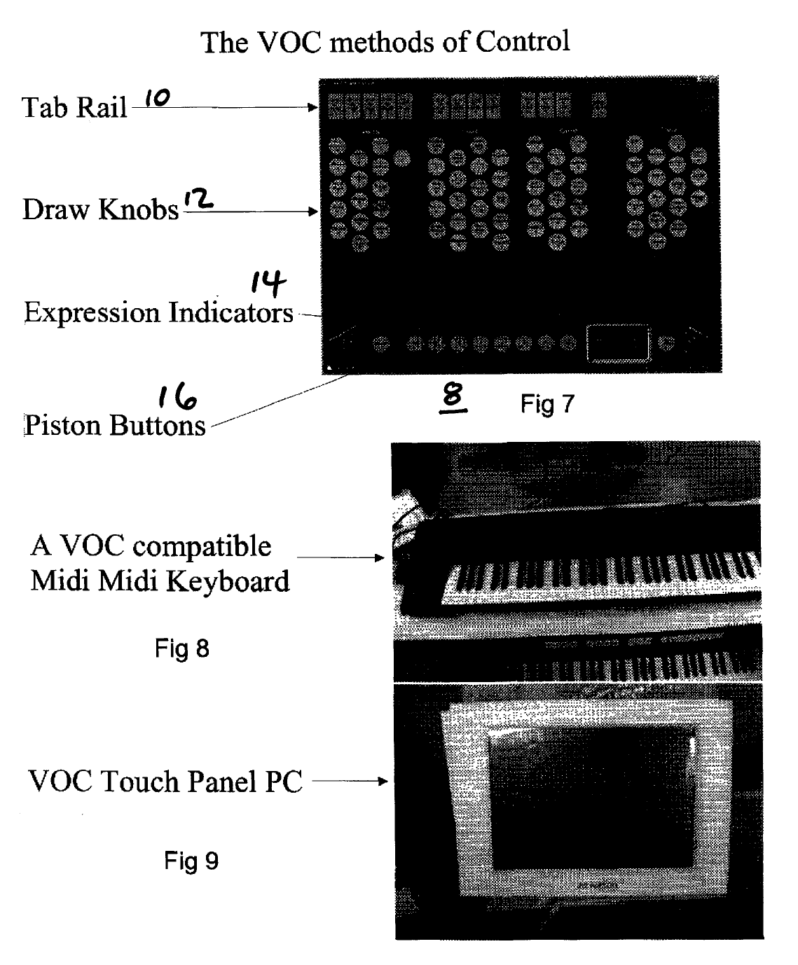

Referring to FIG. 7, further details of the touch-sensitive electronic display panel 8 are shown, including tab rail 10, draw knobs 12, expression indicators 14, and piston buttons 16.

FIG. 8 shows a typical MIDI keyboard of the type used in the virtual organ console of this invention. FIG. 9 illustrates the type of touch-sensitive screen display panel which may be used in the virtual organ console of this invention.

While a preferred embodiment of the invention has been disclosed in detail, it should be understood by those skilled in the art that various modifications can be made to the illustrated embodiment without departing from the scope of the invention as described in the specification and defined in the appended claims.

1. A virtual organ console system comprising;
a. at least one electronic keyboards for selecting particular notes to be played by an organ voice generation system controlled by the virtual organ console,
b. a computer in communication with said at least one electronic keyboards;
c. touch-sensitive screen display panel in communication with said computer upon which are electronically displayed icons representing a plurality of musical organ controls;
d. an electronic control circuitry in said computer for receiving electronic inputs from said at least one electronic keyboards, and from said electronic touch-sensitive screen display panel, processing said electronic inputs, and providing electronic data to control the operation of an organ voice generation system.

2. A virtual organ console system as in claim 1 wherein said plurality of musical organ controls includes a tab rail.

3. A virtual organ console system as in claim 1 wherein said plurality of musical organ controls includes a set of draw knobs.

4. A virtual organ console system as in claim 1 wherein said plurality of musical organ controls includes a tab rail.

5. A virtual organ console system as in claim 1 wherein said plurality of musical organ controls includes at least one expression indicators.

6. A virtual organ console system as in claim 1 wherein said plurality of musical organ controls includes a plurality of piston buttons.

7. A virtual organ console system as in claim 1 wherein said organ voice generation system comprises a set of acoustic organ pipes driveable by pipe driver boards in communication with said personal computer.

8. A virtual organ console system as in claim 1 wherein said organ voice generation system comprises a synthetic sound generator in communication with said personal computer.
